(19) United States
(12) Patent Application Publication
(10) Pub. No.: US 2012/0141152 A1
(43) Pub. Date: Jun. 7, 2012

(54) IMAGE FORMING APPARATUS AND IMAGE BEARING MEMBER DRIVING METHOD

(75) Inventor: Masaya Tanaka, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/313,530

(22) Filed: Dec. 7, 2011

Related U.S. Application Data
(60) Provisional application No. 61/420,562, filed on Dec. 7, 2010.

(30) Foreign Application Priority Data
Feb. 25, 2011 (JP) 2011-039306

(51) Int. Cl. G03G 15/00

(52) U.S. Cl. 399/43

(57) ABSTRACT

According to one embodiment, an image forming apparatus includes: an input section, an image bearing member, a transfer member, a cleaning section, and a control section configured to calculate, if the number of continuously printed sheets in one printing job input from the input section is equal to or larger than a first number of sheets, a printing ratio of a document image of the printing job, determine on the basis of the calculated printing ratio whether the image bearing member is caused to perform rotation opposite to the rotation during the transfer, and suspend printing under execution and drive to reversely rotate the image bearing member according to a determination result.

### CROSS-REFERENCE TO RELATED APPLICATION

This application is based upon and claims the benefit of priority from the prior U.S. Provisional Application No. 61/420,562 filed on Dec. 7, 2010, and Japanese Patent Application No. 2011-039306 filed on Feb. 25, 2011, the entire contents of both of which are incorporated herein by reference.

### FIELD

Embodiments described herein relate generally to an image forming apparatus and an image bearing member driving method for the image forming apparatus.

### BACKGROUND

In an image forming apparatus of an electro photographic system, a toner image is formed on the surface of an image bearing member and transferred onto a transfer medium such as paper. Any toner remaining on the surface of the image bearing member without being transferred and any other deposits are removed by a cleaning blade or the like.

In such an image forming apparatus, the toner and the like are deposited near an edge of the blade because of repeated printing and can cause cleaning failure and deterioration in image quality. Therefore, an operation for reverse rotating the image bearing member is performed every time a job ends or at a time corresponding to the number of sheets printed, the amount of information printed, or the like, whereby the deposits near the edge of the blade are removed and cleaning failure and deterioration in image quality are prevented.

However, if a large amount of printing is continuously performed in one printing job, even if the reversing operation of the image bearing member is simply performed after the end of a print job, it is likely that a deficiency such as a cleaning failure can occur during the printing. Therefore, it is desired to suspend the printing halfway and perform the reversing operation of the image bearing member.

### DESCRIPTION OF THE DRAWINGS

FIG. 1 is a schematic diagram of an image forming apparatus according to a first embodiment;

FIG. 2 is a schematic diagram of an image forming unit according to the first embodiment;

FIG. 3 is a block diagram of a processing section of the image forming apparatus according to the first embodiment;

FIG. 4 is a flowchart for explaining a reversing operation of an image bearing member in the first embodiment:

FIG. 5 is a flowchart for explaining the reversing operation of the image bearing member in the first embodiment;

FIG. 6 is a flowchart for explaining the reversing operation of the image bearing member in the first embodiment:

FIG. 7 is a flowchart for explaining a reversing operation of an image bearing member in a second embodiment;

FIG. 8 is a flowchart for explaining the reversing operation of the image bearing member in the second embodiment; and

FIG. 9 is a flowchart for explaining the reversing operation of the image bearing member in the second embodiment.

### DETAILED DESCRIPTION

According to an embodiment, an image forming apparatus includes an input section configured to receive input of printing conditions including a number of printed sheets. An image bearing member configured to bear an image by a developer corresponding to an input document image and driven to rotate. A transfer member configured to transfer the image by the developer on the image bearing member, which is driven to rotate, onto a transfer medium. A cleaning section configured to remove, after the transfer by the transfer member, the developer deposited on the image bearing member. A control section configured to calculate, if a number of continuously printed sheets in one printing job input from the input section is equal to or larger than a first number of sheets, a printing ratio of a document image of the printing job, determine on the basis of the calculated printing ratio whether the image bearing member needs to perform rotations in a direction opposite to the rotation performed during the transfer, and suspend printing under execution and reversely rotate the image bearing member according to a determination result.

Embodiments are explained below with reference to the accompanying drawings.

### First Embodiment

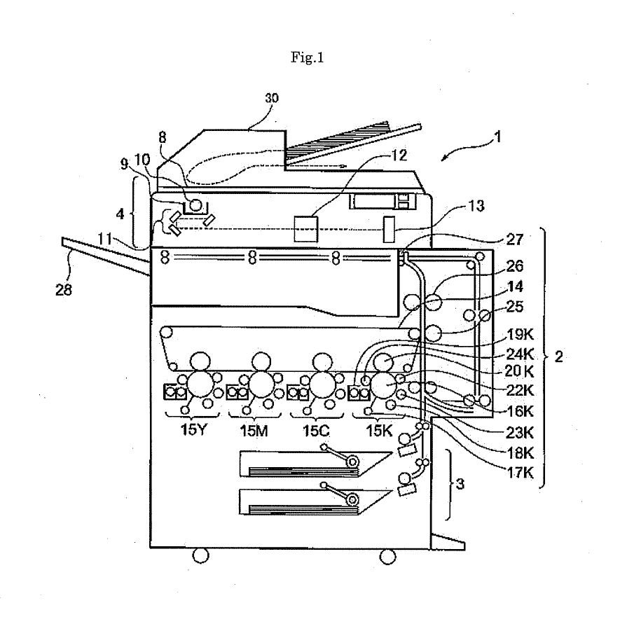

A first embodiment is explained with reference to FIGS. 1 to 6. FIG. 1 is a schematic sectional view of an image forming apparatus according to the first embodiment.

An image forming apparatus 1 includes an image reading section 4 configured to capture an original document as image data and an image forming section 2 configured to output the image data as a visible image. The image forming section 2 includes an image forming unit explained later, which includes an image bearing member such as a drum-like photoconductive member, and a fixing device and the like. The image forming apparatus 1 further includes a sheet feeding section 3 capable of feeding sheets P of an arbitrary size, which are used as recording media for images, to the image forming section 2.

The image reading section 4 includes a light transmissive document placing table 8, a carriage 9, an exposure lamp 10, a reflection mirror 11, an imaging lens 12 configured to converge reflected light, and a CCD (Charge Coupled Device) 13 configured to convert image information obtained by the reflected light into an analog signal.

Image forming units 15Y, 15M, 15C, and 15K included in the image forming section 2 and configured to store color materials of yellow (Y), magenta (M), cyan (C), and black (K) have the same configuration. The image forming units 15Y, 15M, 15C, and 15K perform the same operation. Therefore, the image forming unit 15K for black (K) is explained as an example.

The image forming unit 15K includes a laser unit 17K configured to form an electrostatic latent image on a drum-like photoconductive member 16K functioning as an image bearing member. The image forming unit 15K includes a charging device 18K, a developing device 19K, a cleaner 22K, and a charge removing lamp 23K sequentially arranged around the photoconductive member 16K. The configuration of the image forming unit is explained later.

An original document to be copied is placed on the document placing table 8 or set in a publicly-known auto document feeder 30 arranged on the document placing table 8. If a copy button present on an operation panel 101 is pressed, exposing means including a carriage 9 and an exposure lamp 10 provided in the carriage 9 irradiates light, from below the document placing table 8, on the original document on the document placing table 8 or the original document sent to an exposing device of the document placing table 8 by the auto document feeder 30. Reflected light from the original document is led by the reflection mirror 11 and converged by the imaging lens 12. A reflected light image is projected on the CCD 13. The light from the exposure lamp 10 scans a document surface in synchronization with the movement of the carriage 9 (in FIG. 1, from the left to the right). The CCD 13 captures this scanning light as image information. The captured image information is output as an analog signal and then converted into a digital signal. Thereafter, the image information converted into the digital signal is subjected to image processing according to necessity and then transmitted to the laser unit 17K as image data. The image information converted into the digital signal may be temporarily stored in a recording device such as an HDD (Hard Disk Drive).

In the image forming section 2, when image formation is started, the charging device 18K supplies charges to the outer circumferential surface of the rotating photoconductive member 16K and charges the outer circumferential surface of the photoconductive member 16K to uniform potential. Subsequently, the laser unit 17K irradiates a laser beam, which is modulated by the image data transmitted from the CCD 13, on the outer circumferential surface of the photoconductive member 16K. The laser beam is scanned along a rotation axis of the drum-like photoconductive member 16K. An electrostatic latent image corresponding to the image data is formed and retained on the outer circumferential surface of the rotating photoconductive member 16K. Further, the developing device 19K supplies a color material (a developer) such as a toner to the outer circumferential surface of the photoconductive member 16K. The electrostatic latent image is converted into a toner image, i.e., a developed image.

The developing device 19K includes a developing roller 24K provided to freely rotate. The developing roller 24K is arranged to be opposed to the photoconductive member 16K and rotates to thereby supply the toner to the photoconductive member 16K. If the toner image is formed on the outer circumferential surface of the photoconductive member 16K, the toner image is electrostatically transferred onto an intermediate transfer belt 14 (a transfer medium) by a primary transfer roller 20K functioning as a transfer member.

The cleaner 22K removes the toner remaining on the photoconductive member 16K without being transferred. Further, the charge removing lamp 23K removes residual charges on the outer circumferential surface of the photoconductive member 16K. If a color image is formed, the operation explained above is performed in the same manner in the image forming units 15Y, 15M, and 15C. Therefore, a color image obtained by transferring the color materials to be superimposed one on top of another is formed on the intermediate transfer belt 14.

The toner image transferred onto the intermediate transfer belt 14 is electrostatically transferred onto a sheet, which is conveyed from the sheet feeding section 3 through a conveying path, by a secondary transfer roller 25. Thereafter, the sheet having the toner image transferred thereon is conveyed to a fixing device 26. The toner image transferred onto the sheet is fixed on the sheet by the fixing device 26. The sheet having the toner image fixed thereon, for which the image formation is completed, is discharged onto a sheet tray 28 functioning as a discharge section by a conveying roller 27.

In the above explanation, the printing of the color image is explained. Therefore, the transfer medium to which the toner image on the photoconductive member is transferred is the transfer belt. However, in the case of monochrome printing, a sheet is the transfer medium. Therefore, in this case, the secondary transfer roller is the transfer member.

The overview of the operation for forming an image on the sheet serving as the recording medium is explained above.

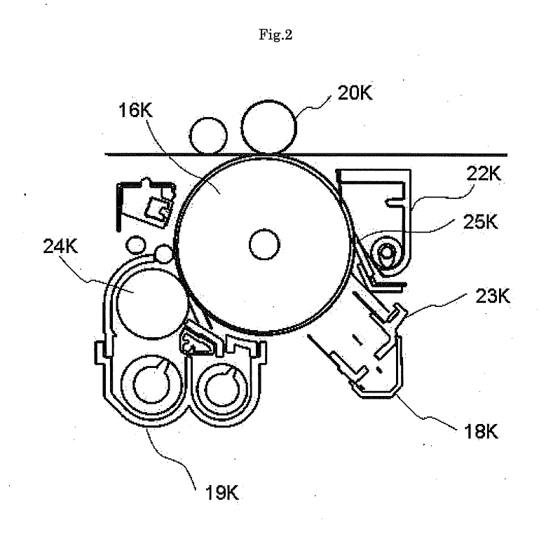

Details of the image forming units 15Y, 15M, 15C, and 15K are explained with reference to FIG. 2. As explained above, the image forming units 15Y, 15M, 15C, and 15K for Y, M, C, and K have the same configuration.

FIG. 2 is a sectional view of the structure of the image forming unit. As explained above, the image forming units for Y, M, C, and K have the same configuration. Therefore, the image forming unit 15K for K is explained as an example. The cleaner 22K includes a cleaning blade 25K. The cleaner 22K removes residual toner from the surface of the photoconductive member 16K with the cleaning blade 25K set in contact with the surface of the photoconductive member 16K.

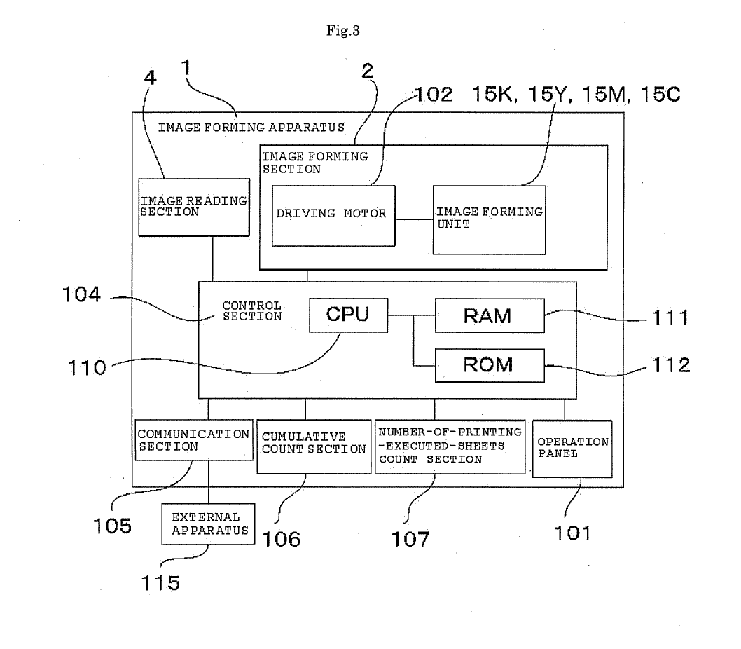

A control system of the image forming apparatus 1 according to this embodiment is explained. FIG. 3 is a block diagram of the control system of the image forming apparatus 1 according to this embodiment.

The image forming apparatus 1 according to this embodiment includes an operation panel 101, the image reading section 4 and the image forming section 2 explained above, a control section 104, a communication section 105 configured to perform communication with an external apparatus 115, a cumulative count section 106 (a first count section) configured to count a cumulative total of the number of printed sheets of plural printing jobs, a number-of-printing-executed-sheets count section 107 (a second count section) configured to count the number of printing-executed sheets for which printing is executed during the printing and the like. Examples of the external apparatus 115 include a PC (Personal Computer) including a printer driver of the image forming apparatus 1. It is possible to send a printing instruction or printing conditions such as the number of printed sheets to the image forming apparatus 1 via the printer driver of the external apparatus 115. Therefore, the external apparatus 115 can function as an input section for the image forming apparatus 1.

The operation panel 101 is a user interface that functions as an input section and to which an operation instruction and the like from a user can be input. The operation panel 101 can include hard keys such as a ten key and touch keys of a display section of a display device incorporating a touch panel such as an LCD (Liquid Crystal Display). The user inputs an operation instruction or printing conditions such as the number of printed sheets via the operation panel 101.

As explained above, the image forming section 2 includes the image forming units 15Y, 15M, 15C, and 15K for Y, M, C, and K. The image forming section 2 further includes a driving motor 102 functioning as a driving section configured to perform, for example, driving of image bearing members of the image forming units 15Y, 15M, 15C, and 15K, and the like.

The control section 104 includes a CPU (Central Processing Unit) 110, a RAM (Random Access Memory) 111, and a ROM (Read Only Memory) 112. The CPU 110 is a processor configured to manage the control of the entire control section 104. The RAM 111 is a memory configured to temporarily store data for work and store data for reference. The ROM 112 is a nonvolatile memory and has stored therein a control program and control data for controlling the image forming apparatus 1. The CPU 110 operates on the basis of the control program stored in the ROM 112. The control section 104 selects a sheet cassette from which a sheet is fed to the image forming section 2. In this embodiment, the CPU 110 is used as the processor. However, the type of processor is not limited to this functionality.

The control section 104 calculates a printing ratio of an original document from image data of an original document read by the image reading section 4 or image data of an original document sent from the external apparatus 115 via the communication section 105.

The printing ratio is 0% in a state where white paper is not printed at all in a printing region. The printing ratio is 100% in a state where the paper is completely printed upon. The printing ratio is defined as a ratio of a printed area and an unprinted area in the printing region.

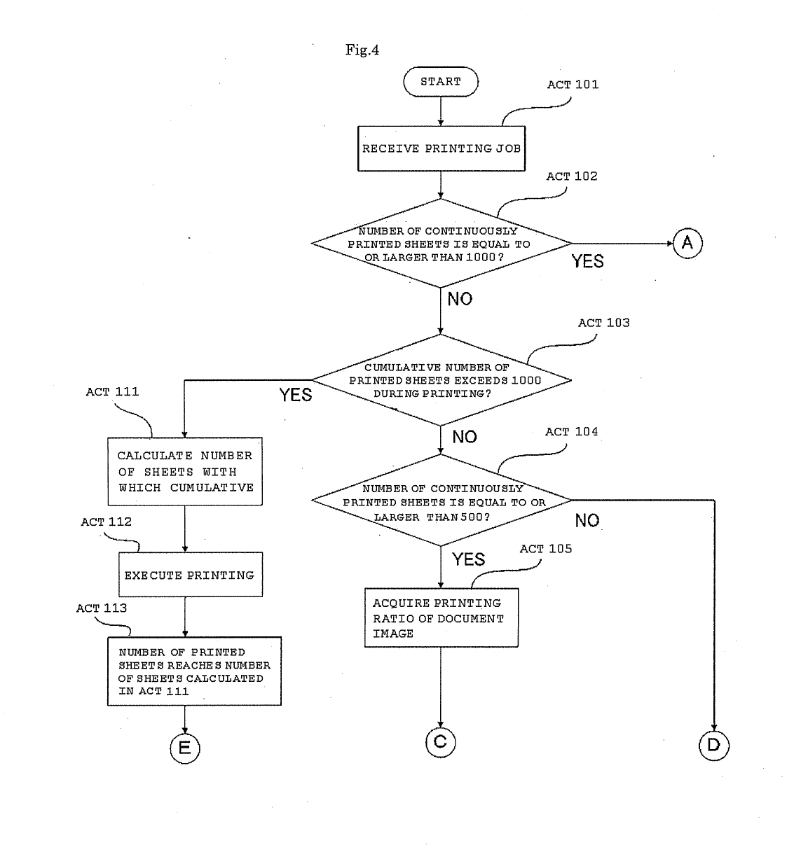

A flow concerning a reversing operation of an image bearing member in performing a large amount printing is explained with reference to a flowchart of FIG. 4. In this embodiment, the reversing operation of the image bearing member is performed if a condition specified in performing a large amount of printing in one printing job is satisfied or if a cumulative total of the number of printed sheets in plural printing jobs counted by the cumulative count section 106 exceeds a predetermined number of sheets. The condition specified in performing a large amount of printing is a condition of a printing ratio.

If a printing ratio of a document image is high, the amount of toner deposited on the image bearing member increases and the amount of the toner remaining on the image bearing member without being transferred onto the recording medium also increases. Therefore, the toner tends to accumulate on an edge surface where the cleaning blade is in contact with the image bearing member. If the printing ratio of the document image is low, the deposited amount of toner on the edge surface of the cleaning blade is small. However, the toner deposited on the edge surface of the cleaning blade is not removed if printing is continuously performed. Therefore, a state exists in which the toner or an externally added agent peeled from the surface of the toner can be continually caught in the same place at the edge surface of the cleaning blade. As a result, the image bearing member can be scratched by the externally added agent. Therefore, when a large amount of printing is performed, the low printing ratio and the high printing ratio of the original document image can be specified as a condition for performing the reversing operation of the image bearing member.

The reversing operation of the image bearing member is explained below using specific numerical values. In this embodiment, for example, printing of five hundred or more sheets is regarded as printing of a large quantity of sheets. In other words, a first number of sheets can be set to five hundred. For example, a printing ratio equal to or lower than 3% can be regarded as a low printing ratio. A printing ratio equal to or higher than 30% can be regarded as a high printing ratio. In other words, a first value of the printing ratio can be set to 3% and a second value of the printing ratio can be set to 30%. When printing a large quantity of sheets, in excess of five hundred sheets, printing can be suspended halfway irrespective of the printing ratio, and the reversing operation of the image bearing member can be performed, for example, if one thousand or more sheets are printed. In other words, a second number of sheets can be set to one thousand. A cumulative specified number (a third number of sheets) of the numbers of printed sheets of plural printing jobs counted by the cumulative count section 106 is set to, for example, one thousand. The first, second, and third numbers of sheets are arbitrarily selected according to the physical properties of a toner in use and performance of the image bearing member and the cleaning blade of the cleaning section irrespective of the above description.

In FIG. 4, the image forming apparatus 1 receives a printing job including printing conditions such as the number of sheets to be printed via the input section such as the operation panel 101 or the external apparatus 115 (Act 101). The control section 104 determines whether the number of sheets to be printed (e.g., the number of continuously printed sheets) associated with the received printing job is equal to larger than one thousand set as the second number of sheets (Act 102). If the number of continuously printed sheets is smaller than one thousand (NO in Act 102), the control section 104 determines on the basis of the number of sheets to be printed associated with the received printing job and a cumulative number of printed sheets counted by the cumulative count section 106 whether the cumulative number of printed sheets of plural jobs exceeds one thousand set as the predetermined number of sheets during the printing (Act 103).

If the control section 104 determines in Act 103 that the cumulative number of printed sheets exceeds one thousand during the printing (YES in Act 103), the control section 104 calculates how many sheets are to be printed in the received printing job when the cumulative number of printed sheets reaches one thousand (Act 111).

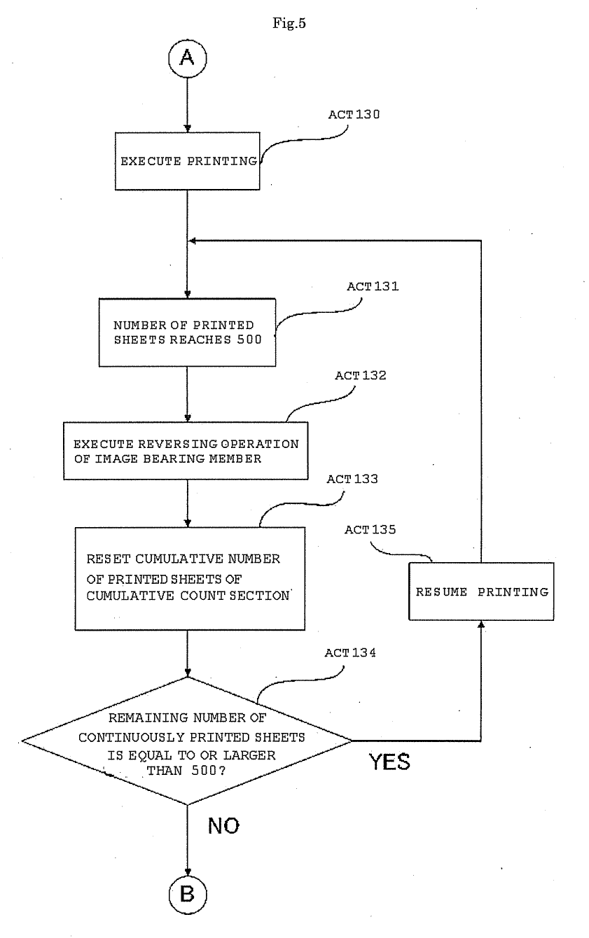

Thereafter, the control section 104 executes printing (Act 112). After the execution of the printing, if the number of printing-executed sheets counted by the number-of-printing-executed-sheets count section 107 reaches the number of sheets calculated in Act 111 (Act 113), the control section 104 suspends the printing and causes the driving motor 102 to execute a reversing operation of the image bearing member (Act 114 in FIG. 5).

If the control section 104 suspends the printing and performs the reversing operation of the image bearing member in Act 114, the cumulative number of printed sheets counted by the cumulative count section 106 is reset (Act 115). If the reversing operation of the image bearing member is completed, the control section 104 resumes the printing (Act 116). Thereafter, the cumulative count section 106 counts the number of printed sheets after the resumption of the printing (Act 117) and the printing job ends. In this case, naturally, the number-of-printing-executed-sheets count section 107 further performs counting. At a point when the value of the count reaches the received number of printing-executed sheets, the printing job ends.

If the control section 104 determines in Act 103 in FIG. 4 that the cumulative number of printed sheets does not exceed one thousand during the printing (Yes in Act 103), the control section 104 determines whether the number of continuously printed sheets of the received printing job is equal to or larger than the five hundred sheets set as the first number of sheets (Act 104). If the control section 104 determines in Act 104 that the number of printed sheets is equal to or is larger than the five hundred sheets (Yes in Act 104), the control section 104 calculates a printing ratio of a document image from image data of an original document read by the image reading section 4 or image data of an original document sent from the external apparatus 115 (Act 105).

The control section 104 determines whether the acquired printing ratio of the document image is equal to or lower than 3% set as the first value or equal to or higher than 30% set as the second value (Act 106 in FIG. 5). If the control section 104 determines in Act 106 that the printing ratio of the document image is equal to or lower than 3% or equal to or higher than 30% (Yes in Act 106), after executing printing in Act 107, the control section 104 performs printing until the number of printed sheets reaches the predetermined number of sheets. In this embodiment, for example, the predetermined number of sheets is set to five hundred. After executing the printing, if the number of printing-executed sheets counted by the number-of-printing-executed-sheets count section 107 reaches five hundred (Act 108), the control section 104 proceeds to Act 114. The control section 104 suspends the printing and performs the reversing operation of the image bearing member. Thereafter, the control section 104 performs the operation in Acts 115 to 117 and the printing job ends.

If the control section 104 determines in Act 103 in FIG. 4 that the number of printed sheets of the printing job is smaller than five hundred (NO in Act 103) or if the control section 104 determines in Act 106 that the printing ratio is larger than 3% or smaller than 30%, the control section 104 causes the image forming section 2 to execute printing (Act 120 in FIG. 5). After the execution of the printing, the control section 104 adds the number of printed sheets of the present printing job to the cumulative number of printed sheets of the cumulative count section 106 (Act 121). Thereafter, the printing job ends.

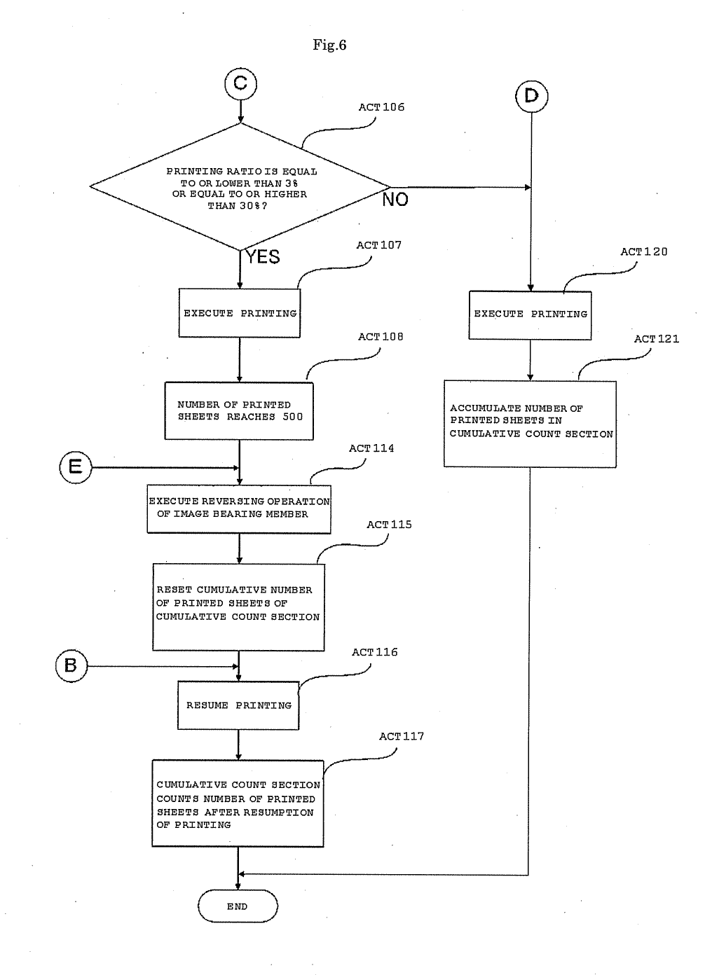

If the control section 104 determines in Act 102 in FIG. 4 that the number of continuously printed sheets is equal to or larger than one thousand (YES in Act 102), the control section 104 causes the image forming section 2 to execute printing (Act 130 in FIG. 6). After the execution of the printing, if the number of printing-executed sheets counted by the number-of-printing-executed-sheet count section 107 reaches five hundred (Act 131), the control section 104 suspends the printing and causes the driving motor 102 to execute the reversing operation of the image bearing member (Act 132).

After causing the driving motor 102 to execute the reversing operation of the image bearing member (Act 132), the control section 104 resets the cumulative number of printed sheets counted by the cumulative count section 106 to an initial value, for example, zero (Act 133). Thereafter, the control section 104 determines whether the remaining number of continuously printed sheets is equal to or larger than five hundred (Act 134). If the control section 104 determines that the remaining number of continuously printed sheets is equal to or larger than five hundred (YES in Act 134), after resuming the printing (Act 135), the control section 104 returns to Act 131 and repeats the acts explained above.

If the control section 104 determines in Act 134 that the remaining number of continuously printed sheets is smaller than five hundred (No in Act 134), the control section 104 proceeds to Act 116 (FIG. 5) and performs the same acts, and the printing job ends.

As explained above, the control of the reversing operation of the image bearing member is performed on the basis of the number of printed sheets and the printing ratio of the received printing job. The control of the reversing operation is performed on the basis of the cumulative number of printed sheets of the numbers of printed sheets of plural jobs as well. This is for the purpose of periodically performing the reversing operation and preventing a cleaning failure of the image bearing member even if printing jobs continue in which it is determined that it is unnecessary to reversely rotate the image bearing member in the control of the reversing operation of the image bearing member performed for each printing job.

By adopting the embodiment explained above, when a large amount of printing is continuously performed in one printing job, it is possible to prevent an image failure due to accumulation of deposits near the cleaning blade from occurring during printing. Even if a large quantity of sheets are continuously printed, if it is determined according to a printing ratio that it is unnecessary to perform the reversing operation of the image bearing member during the printing, the printing is suspended and the reversing operation of the image bearing member is not performed. Therefore, it is possible to prevent deterioration of the image bearing member caused by performing unnecessary reverse rotation of the image bearing member and realize an extension of the life of the image bearing member. Further, it is possible to prevent time required for printing from increasing because of an unnecessary reversing operation of the image bearing member.

By taking into account a cumulative total of the numbers of printed sheets of plural printing jobs, not only when the number of continuously printed sheets is large, it is possible to determine timing of a necessary reversing operation of the image bearing member according to accumulation of the plural printing jobs.

In the embodiment, printing is suspended halfway and the reversing operation of the image bearing member is performed at a point when the cumulative number of printed sheets reaches the predetermined number of sheets. However, the reversing operation of the image bearing member may be performed after completion of a printing job under execution. For example, if the number of printed sheets is small, even if the cumulative number of printed sheets reaches the predetermined number of sheets during the printing, the necessity for suspending the printing and performing the reversing operation of the image bearing member is low. In such a case, it is desirable to perform reverse rotation of the image bearing member after the completion of the printing job because it is possible to prevent an increase in time required for the printing. Therefore, it is also effective that a threshold is set for the number of printed sheets of a printing job and, if the number of printed sheets is equal to or smaller than the threshold, the reversing operation of the image bearing member is not performed during printing and is performed after completion of the printing job.

### Second Embodiment

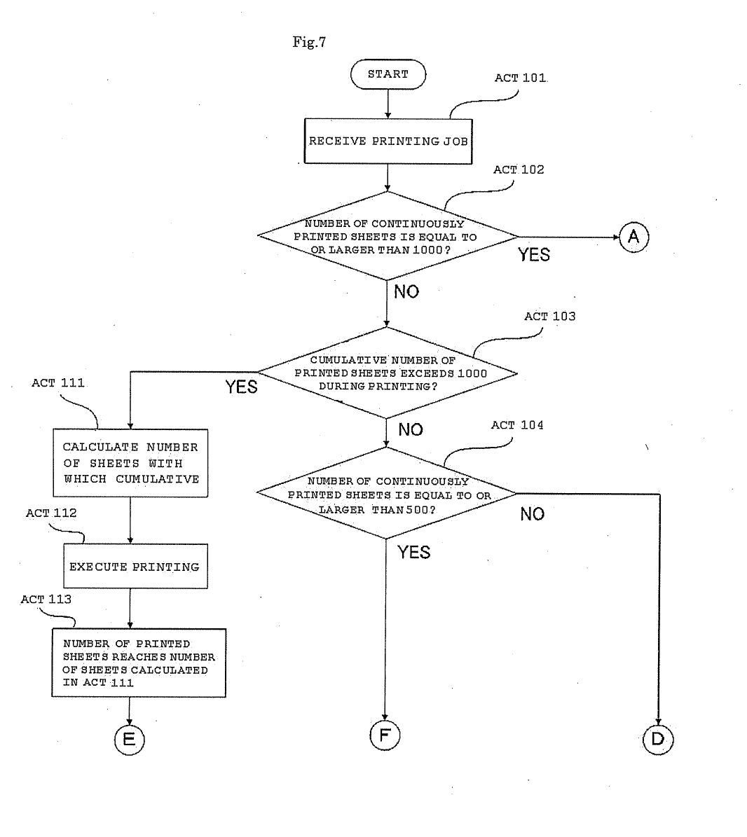

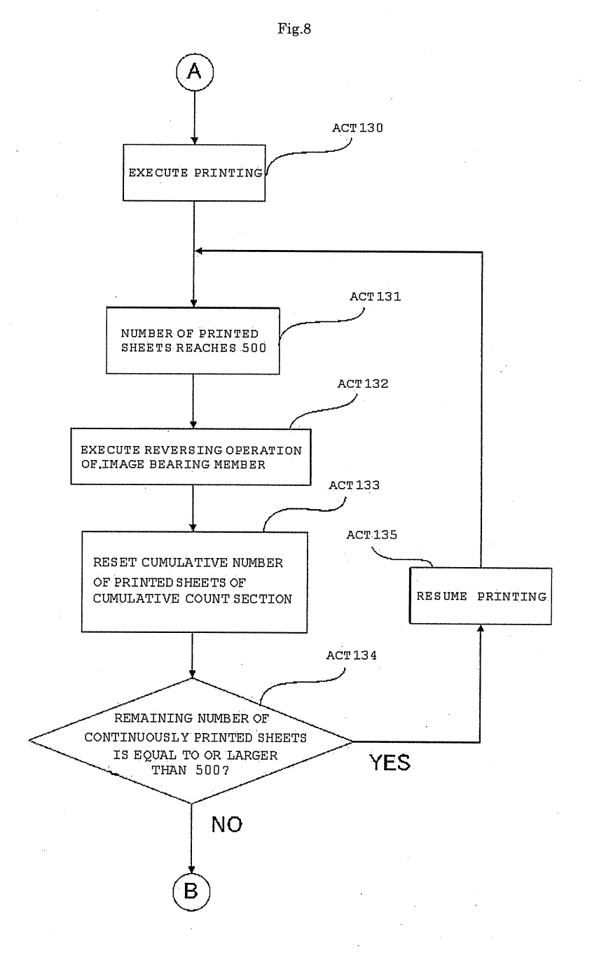

A second embodiment is explained with reference to FIGS. 7 to 9. Components the same as those in the first embodiment are denoted by the same reference numerals and signs. Only characteristic parts of this embodiment are explained.

In the first embodiment, it is assumed that an original document includes one page to be printed. However, in the second embodiment, processing for printing an original document including plural pages is explained.

FIG. 5 is a flowchart for explaining an operation performed when a printing request for an original document including plural pages is received in this embodiment. Acts common to the acts in the flowchart of FIG. 4 in the first embodiment are denoted by the same signs and explanation of the acts is omitted.

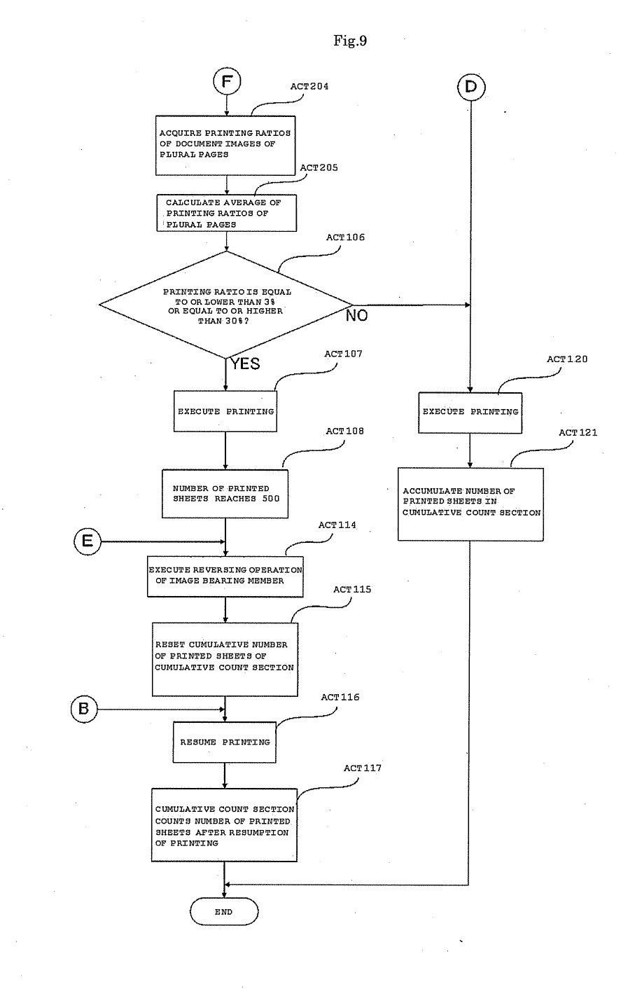

If the control section 104 determines in Act 104 in FIG. 7 that the number of printed sheets is equal to or larger than five hundred (YES in Act 104), the control section 104 acquires printing ratios of all the pages of the original document including plural pages (Act 204 in FIG. 9). Thereafter, the control section 104 calculates an average of the printing ratios of the original document including plural pages acquired in Act 204 (Act 205). The control section 104 determines whether the average printing ratio calculated in Act 205 is equal to or lower than 3% or equal to or higher than 30% (Act 206).

If the control section 104 determines in Act 205 that the calculated average printing ratio is equal to or lower than 3% or equal to or larger than 30% (YES in Act 206), as shown in FIG. 9, the control section 104 performs Act 107 and subsequent acts of the flowchart in the first embodiment.

If the control section 104 determines in Act 206 that the average printing ratio is higher than 3% or lower than 30% (NO in Act 206), similarly, the control section 104 performs Act 120 and subsequent acts of the flowchart in the first embodiment.

According to this embodiment, even if an original document including plural pages is continuously printed in a large quantity, it is possible to control the reversing operation of the image bearing member on the basis of the number of printed sheets and a printing ratio and perform the reversing operation of the image bearing member only when necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an input section configured to receive input of printing conditions including a number of printed sheets;
an image bearing member configured to bear an image in a developer corresponding to an input document image and driven to rotate;
a transfer member configured to transfer the image in the developer on the image bearing member, which is driven to rotate, onto a transfer medium;
a cleaning section configured to remove, after the transfer of the image in the developer by the transfer member, the developer deposited on the image bearing member; and
a control section configured to calculate, if a number of continuously printed sheets in one printing job input from the input section is equal to or larger than a first number of sheets, a printing ratio of a document image of the printing job, determine on the basis of the calculated printing ratio whether the image bearing member should perform a rotation in a direction opposite to the rotation during the transfer, and suspend printing under execution and reversely rotate the image bearing member according to a determination result.

2. The apparatus according to claim 1, wherein, if the input number of continuously printed sheets is equal to or larger than the first number of sheets and smaller than a second number of sheets, the control section suspends the printing under execution and reversely rotates the image bearing member if the printing ratio is smaller than a first value or the printing ratio is larger than a second value or larger than the first value.

3. The apparatus according to claim 2, wherein, if the number of continuously printed sheets is equal to or larger than the second number of sheets, the control section suspends the printing under execution and reversely rotates the image bearing member irrespective of the printing ratio.

4. The apparatus according to claim 3, further comprising a second count section configured to count a number of printed sheets of printing executed in the one printing job, wherein
the control section reversely rotates the image bearing member if a count value of the second count section reaches the first number of sheets or the second number of sheets during execution of the printing.

5. The apparatus according to claim 2, further comprising a first count section configured to count a cumulative total of numbers of printed sheets of plural printing jobs, wherein
the control section reversely rotates the image bearing member if a cumulative number of printed sheets counted by the first count section reaches a third number of sheets that is larger than the first number of sheets.

6. The apparatus according to claim 5, further comprising a second count section configured to count a number of printing-executed sheets of a printing job under execution, wherein
the control section determines whether the cumulative number of printed sheets counted by the first count section exceeds the third number of sheets during the execution of the printing job and, if the cumulative number of printed sheets counted by the first count section exceeds the third number of sheets during the execution of the printing job, suspends the printing job during the execution if a count value of the second count section reaches a necessary number of sheets until the cumulative number of printed sheets reaches the third number of sheets or executes the reverse rotation driving of the image bearing member after the printing job under execution is completed.

7. The apparatus according to claim 6, wherein the cumulative number of printed sheets of the first count section is reset to an initial value if the reverse rotation driving of the image bearing member is executed.

8. The apparatus according to claim 2, wherein, if an original document including plural pages is printed in one printing job, the control section calculates printing ratios of images of the pages of the original document, averages the calculated printing ratios of the pages, and determines on the basis of an averaged printing ratio whether the image bearing member is driven to reversely rotate.

9. An image bearing member driving method comprising:
receiving a printing job that includes printing conditions, the printing conditions include a number of printed sheets and a document image to be printed;
driving an image bearing member to rotate in order to form an image corresponding to the document image with a developer on the basis of the printing job;
determining whether a number of continuously printed sheets of the received printing job is equal to or larger than a predetermined number of sheets;
calculating a printing ratio of the document image of the printing job if the number of printed sheets is equal to or larger than the predetermined number of sheets, determining on the basis of the calculated printing ratio whether the image bearing member is caused to perform rotation opposite to the rotation for the image formation during the printing, and suspending the printing halfway to reversely rotate the image bearing member according to a determination result.

10. The method according to claim 9, further comprising, if the number of continuously printed sheets of the printing job is equal to or larger than a first number of sheets or is equal to or larger than the predetermined number of sheets and is smaller than a second number of sheets, suspending the printing and reversely rotating the image bearing member if the printing ratio is smaller than a first value or the printing ratio is larger than a second value that is larger than the first value and, if the number of continuously printed sheets is equal to or larger than the second number of sheets, suspending the printing and reversely rotating the image bearing member irrespective of a value of the printing ratio.

11. The method according to claim 10, further comprising:
counting a cumulative total of numbers of printed sheets of plural printing jobs; and
reversely rotating the image bearing member if a counted cumulative number of printed sheets reaches a predetermined number of sheets.

12. The method according to claim 10, further comprising:
calculating, if an original document including plural pages is printed in one printing job, printing ratios of images of the pages of the original document;
averaging the calculated printing ratios of the pages; and
determining on the basis of an averaged printing ratio whether printing under execution is temporarily suspended and the image bearing member is reversely rotated.
